(19) United States
(12) Patent Application Publication
(10) Pub. No.: US 2025/0138505 A1
(43) Pub. Date: May 1, 2025

(54) Sequenced Approach for Determining Wafer Path Quality

(71) Applicant: PDF Solutions, Inc., Santa Clara, CA (US)

(72) Inventors: Tomonori Honda, Santa Clara, CA (US); Richard Burch, McKinney, TX (US); Jeffrey Drue David, San Jose, CA (US)

(73) Assignee: PDF Solutions, Inc., Santa Clara, CA (US)

(21) Appl. No.: 19/004,177

(22) Filed: Dec. 27, 2024

Related U.S. Application Data
(63) Continuation of application No. 17/459,657, filed on Aug. 27, 2021, now abandoned.
(60) Provisional application No. 63/071,981, filed on Aug. 28, 2020.

(51) Int. Cl. G05B 19/18; G05B 19/406

(52) U.S. Cl. CPC G05B 19/188; G05B 19/406; G05B 2219/45031

(57) ABSTRACT

Wafer quality is determined by modeling equipment history as a sequence of events, then evaluating anomalous results for individual events. Identifying an event that generates bad wafers narrows the list of possible root causes.

### CROSS REFERENCE

This application claims priority from U.S. Provisional Application No. 63/071,981 entitled Event Sequence Driven Approach to Determine Quality of Wafer Path for Semiconductor Applications, and from U.S. application Ser. No. 17/459,657 entitled Sequenced Approach for Determining Wafer Path Quality, both of which are incorporated herein by reference.

### TECHNICAL FIELD

This application relates generally to determination of root cause(s) for semiconductor wafer excursions, and more particularly, to identifying particular sequences of processing that are linked to production of off-quality wafers.

### BACKGROUND

The determination of a root cause for a semiconductor production problem is a well-known but difficult issue. Systems for classification and anomaly detection typically rely upon analysis of extensive data obtained from production runs to evaluate data excursions from expected values. It would be desirable to have effective tools for narrowing the scope of possible causes to thereby simply classification schemes.

In this disclosure, the transitions from one step to another (or one piece of equipment to another) in a fabrication facility are evaluated to identify those transitions, and in particular, pairs of transitions, that are critical for distinguishing classes of wafers, most simply, good wafers or bad wafers.

### DESCRIPTION OF DRAWINGS

FIG. 1 is block diagram illustrating a processing paths for a portion of a semiconductor process.

FIG. 2 is a graphical plot of true positive results vs. false positive results for example step transition data.

### DETAILED DESCRIPTION

This disclosure describes an approach that is useful in determining root cause(s) for semiconductor wafer production quality issues. The approach models semiconductor processing equipment history for wafer or lot production as an event sequence. Probabilities are then computed for each transition between steps or states of a particular semiconductor recipe as the wafer/lot moves from equipment to equipment or chamber to chamber, namely, is this transition likely to lead to good wafers or bad wafers? The computed probabilities for the complete wafer processing path are aggregated and cross-validated to confirm the accuracy of the model.

Because it is common to provide multiple processing paths for selected steps of a process, such as providing multiple lithography chambers that feed multiple etching chambers, it has been recognized that such paired combinations can produce differing quality results. Thus, the objective is to identify a particular sequence of processing steps that accounts for more bad or off-quality wafers/lots than another sequence. This objective can be achieved by returning to the individual probabilities to find and evaluate anomalous transitions. This information will narrow the field of possible root causes, and for that reason, will be an important input for determining root cause.

Of course, a typical semiconductor process may have hundreds of steps to form the desired circuit features, including deposition, diffusion, ion implantation, lithography, etch, metallization, etc., and upon completion of the device, post-fabrication testing. In addition, as noted above, it is common to provide multiple parallel processing paths for selected steps of the recipe. However, having multiple processing paths creates the opportunity for differing quality results, which will be evaluated as shown here.

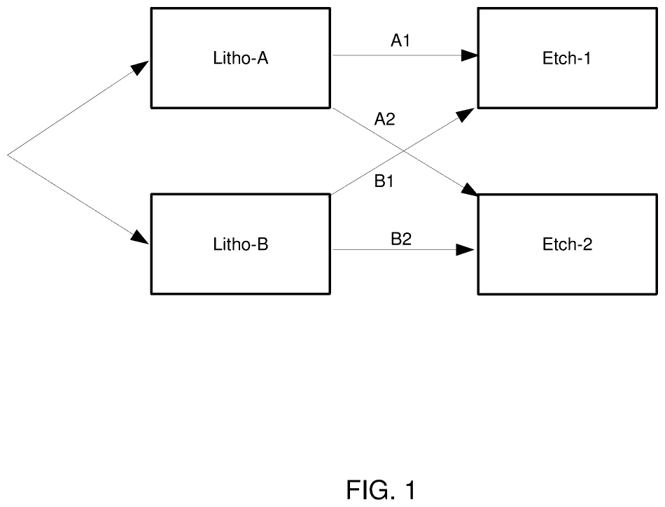

Referring now to FIG. 1, consider as an example a small portion of a semiconductor recipe where there are two possible lithography steps, Litho-A and Litho-B, that feed to a corresponding pair of etching steps, Etch-1 and Etch-2. That is, wafers from Litho-A may be directed along a first path A1 to Etch-1 or a second path A2 to Etch-2, and likewise, wafers from Litho-B may be directed along a first path B1 to Etch-1 or a second path B2 to Etch-2.

In this example, assume that final results from a current production run of this recipe show that 90% of the wafers that are processed along path A1 are acceptable good quality while 10% turn out to be off-quality; conversely, only 10% of the wafers that are processed along path A2 are acceptable good quality, while 90% of the wafers processed along path A2 turn out to be off-quality. Thus, we clearly now know that most of the off-quality wafers come from path A2, while most of the good quality wafers come from path A1. This conclusion indicates that some interaction between Litho-A and Etch-2 is problematic and should be identified and corrected to improve yield. For example, there may be a slight misalignment of the mask in the Litho-A operation that does not severely impact the quality of the wafer after processing in Etch-1. However, the misalignment in Litho-A may be propagated and further impacted by an additional misalignment in the etching step, and the combination of misalignments in Litho-A and Etch-2 cause the wafer to fail quality testing. Identifying path A2 as the culprit narrows the list of possible causes for off-quality wafers to lithography-related issues in Litho-A, etch-related issues in Etch-2, and the transport of wafers from Litho-A to Etch-2.

Thus, a model can be created to evaluate the probabilities at each transition from one step of the process to another step for a particular process path. The transition probabilities are then aggregated to check the performance of the model. If the model produces results that match the production results, then the individual probabilities of each process step can be reviewed to identify the process paths (as event sequences) that lead to anomalous results.

The model can be based on known classification and anomaly detection models for event sequences, including but not limited to a Naïve Bayes classifier, a Markov chain (MC), a hidden Markov model (HMM), and a recurrent neural network (RNN), and is trained on production data from that process path.

As a high-level example, a machine learning model is configured based on a Markov chain stochastic model to evaluate transitions from one state to the next state, the state transition representing a step in the wafer processing path from one piece of equipment (or chamber) to the next piece of equipment (or chamber) in the processing recipe.

The model is generalized by an example of a using a portion of a processing path that proceeds through state i to state j and then on the path to some final state k. For example, equation (1) below computes a fraction T^{good lot} of normal/good wafers that pass to state j from state i, as measured by metrology and other common statistical indicators. The fraction T^{good lot} is equal to the count of normal quality wafers that pass from state i to state j, divided by the sum of counts of normal quality wafers that pass from state i to the final state k.

$${T}_{{state}_{i} , {state}_{j}}^{good lot} = \frac{C N {T}_{s t a t {e}_{i} , stat {e}_{j}}^{good lot}}{{\sum }_{{state}_{{k}_{}}} {CNT}_{{state}_{i} , {state}_{k}}^{good lot}} \qquad ( 1 )$$

Similarly, equation (2) below computes a fraction T^{bad lot} of off-quality/bad wafers that pass to state j from state i. The fraction T^{bad lot} is equal to the count of off-quality wafers that pass from state i to state j, divided by the sum of counts of off-quality wafers that pass from state i to state k.

$${T}_{s t a t {e}_{i} , {state}_{j}}^{bad lot} = \frac{C N {T}_{s t a t {e}_{i} , stat {e}_{j}}^{bad lot}}{{\sum }_{{state}_{k}} {CNT}_{{state}_{i} , {state}_{k}}^{bad lot}} \qquad ( 2 )$$

The final prediction W for each wafer lot is the sum of log-odd transitions, as shown in equation (3) below. The more positive the final prediction W, the more likely it is that the entirety of the processing path leads to normal quality wafers. The more negative the final prediction W, the more likely it is that the processing path leads to off-quality wafers.

$${W}_{k}^{MC} = log ( \frac{{T}_{{state}_{k 1}^{0}}^{good lot}}{{T}_{{state}_{k 1}^{0}}^{bad lot}} ) + {\sum }_{j = s t a t {e}_{k 2}}^{s t a t {e}_{k ( N - 1 )}} log \frac{{T}_{j , j + 1}^{good lot}}{{T}_{j , j + 1}^{bad lot}} \qquad ( 3 )$$

For processing paths that produce more negative results, equation (2) provides a quantification of off-quality at each step along the path, and can be reviewed and analyzed to identify significant fractions Toad lot that require investigation for corrective action. As noted above, by identifying anomalous transitions, the list of possible causes becomes more limited and very likely known as a result. Further, the results of computations from each transition can be provided as inputs to a hierarchical model configured for determining root cause.

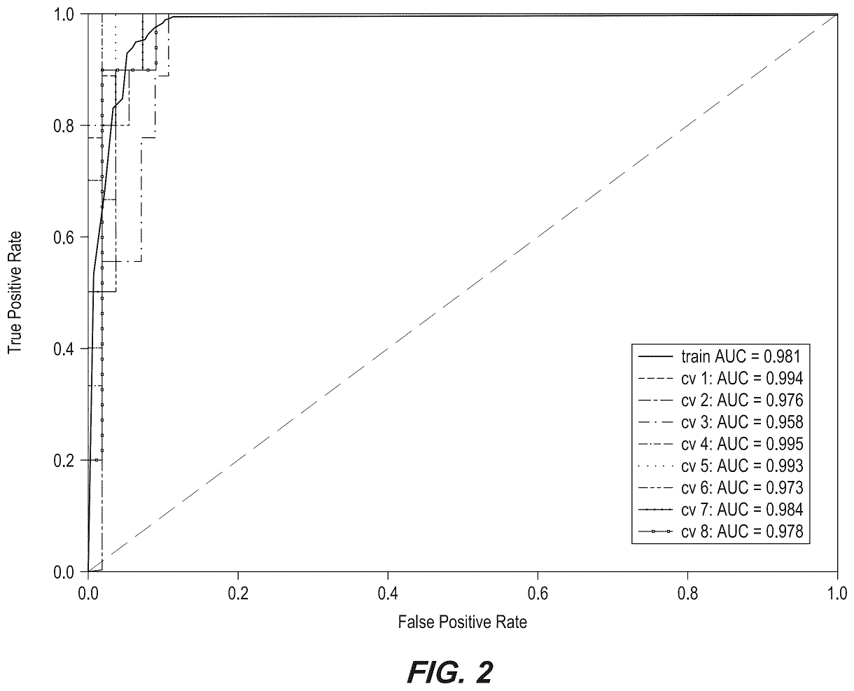

Example data for a prediction W on a training set is shown in FIG. 2, where the area under the ROC curve (AUC) is graphed with a true positive rate is plotted on the y-axis, namely, the model prediction for a good wafer is accurate, versus a false positive rate plotted on the x-axis, namely, the model prediction for a good wafer is not accurate. The data set is put through a k-fold cross validation, with the training set plotted as well as each validation result plotted as cv1, cv2 . . . cv8. From these results, it can be seen that the sets cv1, cv4 and cv5 produce true positive rates exceeding 99% and would be good candidate to use as the model implementation.

This is a promising result for identifying the problematic equipment chains. For example, the model detects that when the wafer goes through a particular sequence of equipment processing, such as equipment A to equipment B to equipment C in that order, the wafer has a statistically significant increase in probability that it will be a bad wafer. This knowledge of sequence and transition probabilities will help customer identify the likely root cause for the bad wafer. Outputs from the model can be provided as inputs to a second model configured for root cause determination, where the equipment-history based inputs can provide significant predictive ability for root cause determinations. Outputs from the model can also be provided to a third model configured to improve the predictability of the first model, for example, through feature engineering and selection to limit inputs to those having a significant predictive ability.

The model needs to handle cases where there is uncertainty in the transition probability due to a small sample size. To do so, transitions that are not statistically significant are removed from the average transition probabilities. Furter, a prefix can be added to all transition counts T. For example, the initial transition counts can be set as follows:

$${CNT}_{{state}_{i} , s t a t {e}_{j}}^{good lot} = x \qquad ( 4 )$$

$${CNT}_{s t a t {e}_{i} , {state}_{j}}^{bad lot} = a * x \qquad ( 5 )$$

where α is the ratio of bad lots to good lots. The transition probability can be recomputed when the model detects a significant change.

A hidden Markov model assumes a Markov model with unobservable hidden states. For this application, internal hidden states can be represented as wafer quality inputs, which produces observables such as intermediate Wafer Acceptance Test (WAT) or Process Control Monitoring (PCM) data, which are test measurements from test structures built in scribe lines and collected during manufacturing steps. Other possible inputs include, but are not limited to, defect data, metrology data, and FDC indicators. The transition probability for this hidden Markov model could be configured as dependent on different processing path scenarios, for example, based on the current equipment in use, the current manufacturing process step, or pairs of equipment (what was used previously and what will be used next), process step pairs, etc.

The modeling of transition probabilities is facilitated by the emergence of parallel processing architectures and the advancement of Machine Learning algorithms which allow users to model problems and gain insights and make predictions using massive amounts of data at speeds that make such approaches relevant and realistic. Machine Learning is a branch of artificial intelligence that involves the construction and study of systems that can learn from data. These types of algorithms, and along with parallel processing capabilities, allow for much larger datasets to be processed, and are much better suited for multivariate analysis in particular.

The creation and use of processor-based models for implementing classification and anomaly detection methods, including computing transition probabilities as described herein, can be desktop-based, i.e., standalone, or part of a networked system; but given the heavy loads of information to be processed and displayed with some interactivity, processor capabilities (CPU, RAM, etc.) should be current state-of-the-art to maximize effectiveness. Additionally, these computations are highly parallelizable in a map-reducing manner, i.e., the computations could run easily in Big Data ecosystems. In the semiconductor foundry environment, the Exensio® analytics platform is a useful choice for building interactive GUI templates. In one embodiment, coding of the processing routines may be done using Spotfire® analytics software version 7.11 or above, which is compatible with Python object-oriented programming language, used primarily for coding machine learning models.

The foregoing description has been presented for the purpose of illustration only—it is not intended to be exhaustive or to limit the disclosure to the precise form described. Many modifications and variations are possible in light of the above teachings.

1. A method of using a machine learning model (MLM) to detect anomalous sequences of processing steps in a semiconductor process, comprising:
(a) training, by a computer, the MLM based on input data and a selected training algorithm to generate a trained MLM, wherein the selected training algorithm includes a classification algorithm and an anomaly detection algorithm, and wherein the input data is equipment history data for a plurality of processing equipment used in a semiconductor process;
(b) wherein a recipe for the semiconductor process includes a plurality of processing steps using the processing equipment, selected ones of the plurality of processing steps having a plurality of parallel processing paths thereby forming a plurality of different processing sequences for performing the semiconductor process;
(c) computing, by the trained MLM, a plurality of transition probabilities for a production run of the semiconductor process, each transition probability representing wafer quality at each of a plurality of transitions between processing steps for each of the plurality of different processing sequences;
(d) aggregating, by the trained MLM, each of the plurality of computed transition probabilities for each of the plurality of different processing sequences;
(e) identifying, by the trained MLM, at least one of the plurality of different processing sequences as having an anomalous quality result;
(f) evaluating, by the trained MLM, each of the individual computed transition probabilities for the at least one processing sequence;
(g) determining, by the trained MLM, that a specific transition of the plurality of transitions for the at least one processing sequence from a first piece of processing equipment to a second piece of processing equipment accounts for the anomalous quality result; and
(h) providing output from the MLM model to a hierarchical model programmed with routines to determine a root cause for the detected anomalous quality result.

2. The method of claim 1, further comprising:
configuring the MLM based on a Markov chain stochastic model to evaluate each of the plurality of transitions as a plurality of state changes from one generalized state i representing one of the plurality of processing equipment to a next generalized state j representing a next one of the plurality of processing equipment in the respective processing sequence, with each of the plurality of processing sequences having a final state k at an end point of the semiconductor process.

3. The method of claim 2, further comprising:
for each of the plurality of state changes:
(i) computing a fraction T1 equal to a first count of normal quality wafers that pass from state i to state j, divided by the sum of second counts of normal quality wafers that pass from state i to the final state k; and
(ii) computing a fraction T2 equal to a third count of off-quality wafers that pass from state i to state j, divided by the sum of fourth counts of off-quality wafers that pass from state i to the final state k;
for each of the plurality of processing sequences, aggregating the plurality of state changes as a sum of log-odd transitions of the computed T1 fractions divided by the computed T2 fractions; wherein a positive aggregated sum indicates a likelihood of normal quality wafers from the corresponding processing sequence, and a more positive aggregated sum indicates a higher likelihood of normal quality wafers from the corresponding processing sequence; and wherein a negative aggregated sum indicates a likelihood of off-quality wafers from the corresponding processing sequence, and a more negative aggregated sum indicates a higher likelihood of off-quality wafers from the corresponding processing sequence; and
evaluating the processing sequences that result in negative aggregated sums.

4. The method of claim 3, further comprising:
wherein fraction T1:
$$T {1}_{s t a t {e}_{i} , {state}_{j}} = \frac{C N {T}_{s t a t {e}_{i} , stat {e}_{j}}^{good lot}}{{\sum }_{{state}_{k}} {CNT}_{{state}_{i} , {state}_{k}}^{good lot}}$$
wherein fraction T2:
$$T {2}_{s t a t {e}_{i} , {state}_{j}} = \frac{C N {T}_{s t a t {e}_{i} , stat {e}_{j}}^{bad lot}}{{\sum }_{{state}_{k}} {CNT}_{{state}_{i} , {state}_{k}}^{bad lot}}$$
wherein aggregation W:
$${W}_{k}^{MC} = log ( \frac{{T}_{{state}_{k 1}^{0}}^{good lot}}{{T}_{{state}_{k 1}^{0}}^{bad lot}} ) + {\sum }_{j = s t a t {e}_{k 2}}^{s t a t {e}_{k ( N - 1 )}} log \frac{{T}_{j , j + 1}^{good lot}}{{T}_{j , j + 1}^{bad lot}}$$
for an identified processing sequence that results in a negative aggregated sum, analyzing the fraction T2 for each state change of the identified processing sequence.

5. The method of claim 1, further comprising:
selecting the MLM from a group consisting of a Naïve Bayes classifier, a Markov chain, a hidden Markov model, and a recurrent neural network; and
training the selected MLM on equipment history data for the semiconductor process.

6. A method of using a machine learning model (MLM) to detect anomalous sequences of processing steps in a semiconductor process, wherein a recipe for the semiconductor process includes a plurality of processing steps each processing step using processing equipment, selected ones of the plurality of processing steps having a plurality of parallel processing paths through selected ones of the processing equipment, comprising:
training the machine learning model (MLM) to detect anomalous processing steps in the semiconductor process by modeling equipment history for the processing equipment used in each processing step of the semiconductor process as a sequence of events from one state i to the next state j;
for each event of the sequence of events, computing a first probability that normal quality wafers pass from a first state i representing a first one of the plurality of processing equipment to a second state j representing a next one of the plurality of processing equipment, and computing a second probability that off-quality wafers pass from the first state i to the second state j;
aggregating the first and second probabilities for each of the plurality of different processing sequences; and
evaluating the individual computed second probabilities for each change from state i to state j for an identified processing sequence where the aggregation indicates a likelihood that off-quality wafers are produced by the identified processing sequence.

7. The method of claim 6, further comprising:
selecting the MLM from a group consisting of a Naïve Bayes classifier, a Markov chain, a hidden Markov model, and a recurrent neural network; and
training the selected MLM on equipment history data for the semiconductor process.
